(19) United States
(12) Patent Application Publication
(10) Pub. No.: US 2004/0230744 A1
(43) Pub. Date: Nov. 18, 2004

(54) Cache content protocol for a content data delivery system

(76) Inventor: Jin Teik Teh, Los Altos, CA (US)

Correspondence Address: Jason Z. Lin, Supreme Patent Services, Post Office Box 2339, Saratoga, CA, 95070-0399, US

(21) Appl. No.: 10/440,384

(22) Filed: May 17, 2003

(51) Int. Cl. G06F 12/00

(52) U.S. Cl. 711/118

(57) ABSTRACT

This invention discloses the cache content protocol for a content data delivery system. The cache content protocol defines a one-row table whose fields comprise three parts: content header, which includes provider ID, application type ID, category ID, and expiration time; extra criteria header, which includes extra criteria field count, criteria field IDs, and content cache record count; and criteria fields and actual data records, in which each record contains extra criteria fields, and respective actual content data, and the number of records is equal to the said content cache record count.

Due to this arrangement, the cache content can be indexed by the following fields: provider ID, application type ID, category ID, and extra criteria fields.

### FIELD OF THE INVENTION

This invention relates to a cache content protocol and, more particularly, to a cache content protocol for a content data delivery system.

### BACKGROUND OF THE INVENTION

A virtual hosting, general purpose delivery platform is to deliver applications and content. The platform server is the server platform that resides within the infrastructure network. The application server, usually is a third-party server and resides outside/inside the customer's local area network, is a server that handles all processes and tasks specific to an application or product or service.

The client device connected in the data delivery network is to be resided by both platform client and application client. The platform client is a thin-client that provides generic functionality to transfer messages between the application servers and the application clients. The platform client provides a controller and shell for application clients to provide services, specialized processes or content to users. The platform client routes data and commands between application clients, and between the application servers and the application clients. As to the application client, it is usually a separate module or process that provides a specific task for the client. It can be a module handling the drawing of vector graphics or the playing of MP3 audio files.

The platform server provides generic functionality for handling user requests and the transfer of messages between application servers and the application clients. It provides transparent integration between each application server and the clients. It also provides a transparent communication gateway to the clients. It routes data and commands between the application server and the application clients. It also provides hosting of data to reduce the number of trips to the application servers.

There are basically two classes of application servers: content application servers and, service application servers. A content application server is an application server that specializes in sending non-personal content. It provides information that requires no subscription, e.g. Stock quotes. On the other hand, a service application server is an application server that provides personalized services. It provides information that requires user registration, e.g. stock trading.

Residing on the platform server, the content cache is a short-to-long term storage used for storing common or public data that can be delivered to one or many users. Examples of such content are stock quotes, sports scores, news, public audio tracks or pay-per-view movies. The content is retrievable by certain criteria such as category or selection criteria.

As there are many types of content data, current methods usually employ URL or ID for specifying the intended data. In these methods, when an application requests data from a cache, it needs to know the unique URL or ID for the data. However, as the ID changes every time content cache is updated with new content, and the URL changes every time the content in content cache changes, the application is required to compose the URL or ID for all the possible changes. This is usually not practical.

This invention provides a method related to cache content protocol for the content delivery between application servers and client devices.

### SUMMARY OF THE INVENTION

The object of the present invention, the cache content protocol for a content data delivery system, is to provide a common protocol in memory cache to optimize retrieval of often-used content, for both application servers and clients.

By defining all types of content data by category and criteria, the cache content protocol of this invention allows searching for the latest content by using a search method of specifying various fields and category criteria. This makes it easy for both application servers and clients to always keep and get the latest content of a subject, without needing to know how the content was previously changed or affected. The retrieval of the content is transparent to the users.

Another object of the present invention is to improve the storage utilization for processing a common data across multiple processes.

In order to achieve the aforementioned purposes, the present invention provides a cache content format which is a one-row table whose fields can be grouped into three portions:

content header, which includes provider ID, application type ID, category ID, and expiration time;

extra criteria header, which includes extra criteria field count, criteria field IDs, and content cache record count; and

criteria fields and actual data records, in which each record contains extra criteria fields, and respective actual content data. And the number of records is equal to the said content cache record count.

That is, the present invention provides a content cache's format protocol so that the cache content can be indexed by the following fields:

provider ID,

application type ID,

category ID, and

extra criteria fields.

### BRIEF DESCRIPTION OF THE DRAWINGS

Other features and advantages of the present invention will become apparent in the following detailed description of the preferred embodiment with reference to the accompanying drawings, of which:

FIG. 1 is a content cache's format protocol which is a one-row table, proposed by this invention;

FIG. 2 is a packed content example delivered by a sport application server, in the preferred embodiment of this invention, and

FIG. 3 is a packed query key example given by a client, in the preferred embodiment of this invention.

### DETAILED DESCRIPTION OF THE PREFERRED EMBODIMENT

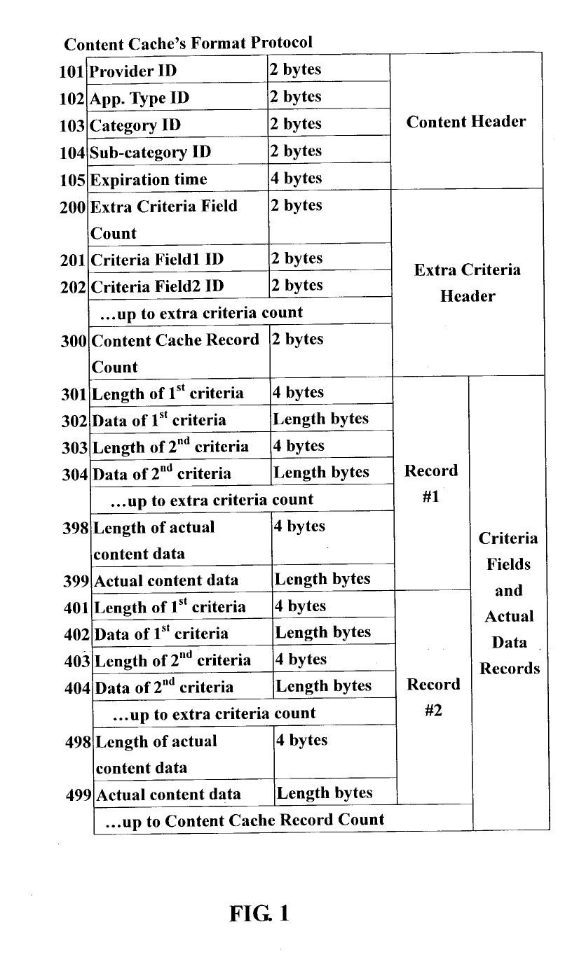

FIG. 1 shows the content cache's format protocol of the preferred embodiment of this invention. At the right part of the format protocol table shown in FIG. 1, a packed cache content's data can be divided into three parts: content header(12 bytes in total), extra criteria header, and criteria fields and actual data records. Each part and its fields will be explained in the following:

Content Header

(1). Provider ID 101: The provider ID denotes the id of an application server. This field is used for distinguishing the application server.

(2). App. Type ID 102: It denotes the application type ID which represents the content related to stock quote, or sports, or weather information, or the news etc.

(3). Category ID 103: There are usually several categories in an application type, for example, in the “stock quote” there may further be categories such as: “cement industry”, “steel industry”, “computer industry”, and etc. Each industry has a category ID, and categories of “sports” may further have “football”, “basketball”, etc.

(4). Sub-category ID 104: Take the “basketball” for example, there may further be sub-categories like “NBA”, or “College Hoops”. This field may be deleted if no sub-category is needed.

(5). Expiration time 204: This field contains the time to remove this cache content.

Extra Criteria Header

(1). Extra criteria field count 200: This field stores the number representing how many criteria fields are used for the search of the content data.

(2). Criteria field1 ID 201: This field stores the id of the 1^{st} criteria.

(3). Criteria field2 ID 202: This field stores the id of the 2^{nd} criteria.

(4). Next to Criteria field2 ID is Criteria field3 ID, and so on, until up to extra criteria field count.

(5). Content cache record count 300: This field stores the number of content cache records.

Criteria Fields and Actual Data Records

(1). This Record #1 contains the following fields: Length 301 which is the length of the 1^{st} criteria, Data 302 which is the value of the 1^{st} criteria, Length 303 which is the length of the 2^{nd} criteria, Data 304 which is the value of the 2^{nd} criteria, in this Record #1, and so on up to extra criteria field count. At the end of this Record #1 are Length 398, which is the length of the actual cache content's data, and Cache Content Data 399 which is the actual cache content's data.

(2). This Record #2 contains the following fields: Length 401 which is the length of the 1^{st} criteria, Data 402 which is the value of the 1^{st} criteria, Length 403 which is the length of the 2^{nd} criteria, Data 404 which is the value of the 2^{nd} criteria, in this Record #2, and so on up to extra criteria field count. At the end of this Record #2 are Length 498, which is the length of the actual cache content's data, and Cache Content Data 499 which is the actual cache content's data.

(3). Next to the Record #2 is the Record #3, and so on up to content cache record count.

This content cache's format protocol has to be followed by all application servers and clients that wish to deliver or retrieve the cache content from the Content Cache Service residing on the platform server.

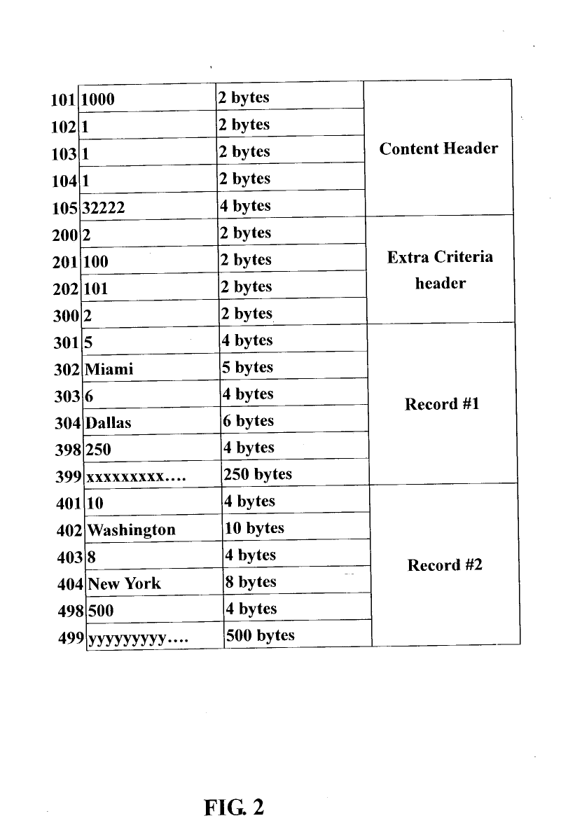

FIG. 2 shows a packed content example delivered by a sport application server, in the preferred embodiment of this invention. As shown in FIG. 2, the fields of content hear have the following values: the value of field 101 is “1000”, which means the ID of this application server is “1000”. The value of field 102 is “1”, which means the content is a “sports information”, the value of field 103 is “1”, which means “basketball”, the value of field 104 is “1”, which means “College Hoops”, and the value of field 105 is “32222”, which means the time being expired.

Also shown in FIG. 2, the fields of the Extra criteria header have the following values: the value of field 200 means the total number of extra criteria fields is 2. The values of field 201 and field 202 are interpreted as “Team #1” and “Team #2”. And the value of field 300 means total number of content cache records following is 2.

The Record #1, shown in FIG. 2, includes field 301, 302, 303, 304, 398, and 399. These fields store the team names of “Miami” and “Dallas” and the related information of these two teams.

The Record #2, on the other hand, includes fields 401, 401, 403, 404, 498, and 499. These fields store the team names of “Washington” and “New York” and the related information of them.

While the platform server receives the above content message, it splits the above data and sends them to Content Cache Service to store into cache. Content Cache Service provides an API named “Create Cache Item”, which extracts each field defined in the table as shown in FIG. 1, and creates a cache item corresponding to this provider, application type, category, sub-category, and etc. The content message containing content header, extra criteria header, and criteria fields and actual data records, is then stored in the cache under the said cache item. The previous cache item will be replaced with the new cache content if provider, application type, category, sub-category and extra criteria fields are already registered in the Content Cache Service.

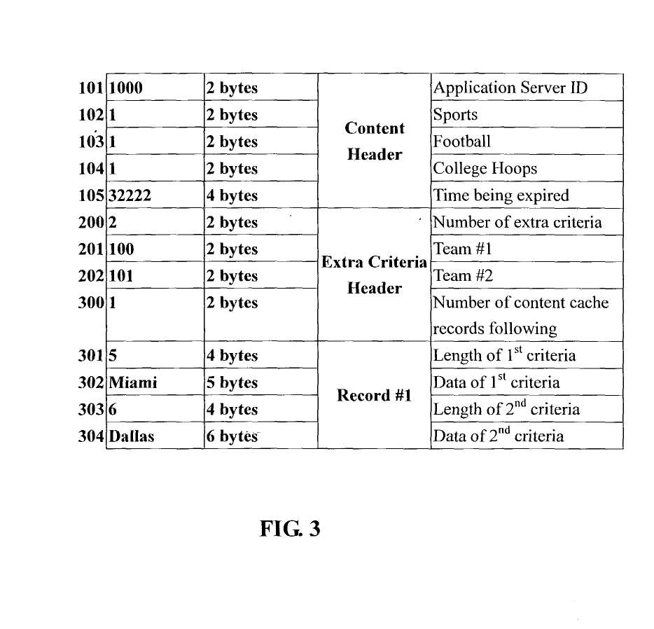

With the content data, as shown in FIG. 2, stored in the cache, if a platform client wants to query the information for team “Miami” and “Dallas”, it needs to pack a data key as shown in FIG. 3 to retrieve the cache data. An API named “Find Cache Item”, provided by Content Cache Service, searches the cache by using the packed data key which can be divided into parts of Content Header, Extra Criteria Header, and Record #1, as shown in FIG. 3. The “Find Cache Item” finds a cache item corresponding to the Content Header and Extra Criteria Header from the cache, and then finds the record with the criteria values of “Miami” and “Dallas” from the cache. Finally, the Content Cache Service will return 250 bytes cache data back to the client.

Having explained a preferred embodiment above, it is to be understood that the invention is not to be limited to the disclosed embodiment, but on the contrary, is intended to cover various modifications and equivalent arrangement included within the spirit and scope of the appended claims.

What is claimed is:

1. In a data delivery system having a platform server,
at least one platform client and one application server in the remote distance,
said platform client accessing content data hosted on said platform server, and
said application server storing content data on the cache of said platform server, a cache content protocol comprising:
a one-row table;
a method for storing content data on said cache; and
a method for retrieving content data from said cache.

2. A cache content protocol claimed as in claim 1, wherein said one-row table having a format comprising a content header part, an extra criteria header part, and a criteria fields and actual data record part.

3. A one-row table claimed as in claim 2, wherein said content header part further comprising a provider ID field, an application type ID field, a category ID field, and an expiration time field; said extra criteria header part, further comprising an extra criteria field count field, a criteria field Ids field, and a content cache record count field; and said criteria fields and actual data records part, wherein each record further comprising extra criteria fields, and respective actual content data, and the number of records equal to said content cache record count.

4. A cache content protocol as claimed in claim 1, wherein said method for storing content data on said cache comprising the steps of:
receiving the request from said application server to store the content data on said cache;
splitting out the packed content data into said content header, said extra criteria header, and said criteria fields and actual data records;
creating a cache item corresponding to said content header and said extra criteria header;
storing criteria fields and actual data records on said cache under said cache item; and
returning a completion message to said request application server.

5. A cache content protocol as claimed in claim 1, wherein said method for retrieving content data from said cache comprising the steps of:
receiving the request from said client to retrieve the content data on said cache;
searching a cache item corresponding to said content header and extra criteria header on said cache;
searching the records from said cache corresponding to criteria fields records; and
returning the all actual data in the criteria fields records, or a fail message, to said request client.
